(19) United States
(12) Patent Application Publication
(10) Pub. No.: US 2006/0194488 A1
(43) Pub. Date: Aug. 31, 2006

(54) Coated metalized fabric and process for edge bonding

(76) Inventor: Trent T. Coghill, Saskatchewan (CA)

Correspondence Address: Steven M. Greenberg, Esquire, Suite 105F, 1300 Corporate Center Drive, Wellington, FL, 33414, US

(21) Appl. No.: 11/130,684

(22) Filed: May 17, 2005

(30) Foreign Application Priority Data
Feb. 28, 2005 (CA) 2,498,744

(51) Int. Cl. B32B 15/14; B32B 5/16; B32B 27/14

(52) U.S. Cl. 442/73; 442/64; 442/72; 442/74; 442/75; 156/73.5

(57) ABSTRACT

An improved coated metalized fabric of man made fibers and a process for bonding the improved fabric to adjacent materials, such as along its edges with adjacent such fabrics.

### CROSS-REFERENCE TO RELATED APPLICATION

This application is related to and claims priority to Canadian Patent Application Serial No. 2,498,774, filed Feb. 28, 2005, the entirety of which is incorporated herein by reference.

### FIELD OF THE INVENTION

The invention relates to coated metalized fabrics and a process for edge bonding such fabrics to adjacent materials.

### BACKGROUND OF THE INVENTION

U.S. Pat. No. 5,744,405 to Okumura issued Apr. 28, 1998 and describes a process of enhancing the adhesion of a thin metal film to a fibre substrate by the addition of a particular silicon intermediate agent.

U.S. Pat. No. 5,955,175 to Culler issued Sep. 21, 1999 and describes a metalized microporous membrane layer.

U.S. Pat. No. 5,271,998 to Duckett issued Dec. 21, 1993. U.S. Pat. No. '998 discloses a process for metalizing a fabric for use as an automobile cover in 3, 4 or 5 steps. In each case a fabric is metalized which is then coated with a particular finishing emulsion of urethane, acrylic and fluorocarbon polymers which then may be optionally dried and then calendered. Duckett addresses deficiencies in wash durability, light stability and the ability to protect a metalized fabric while maintaining a degree of flexibility and finish.

U.S. Pat. No. 5,599,585 to Cohen issued Feb. 4, 1997. U.S. Pat. No. '585 discloses a process for metalizing an elastomeric fabric, particularly formed from an elastomeric web of ‘meltblown’ fibres. The fabric is cooled and may be elongated during the continuous metallization process. U.S. Pat. No. '585 describes prior art efforts in respect of metalized sheet materials for a variety of purposes as limited by the limitations in the substrate sheet itself.

Of particular note is the requirement for a relatively stretch-resistant and inelastic substrate so that the substrate would not deform and cause the metallic coating to detach or flake off. The resultant prior art fabrics lacked adequate flexibility, elasticity, softness and/or drape.

U.S. Pat. No. '585 describes its process as simply metalizing the elastomeric substrate so that at least a portion of the fabric is substantially covered 35 with a metallic coating, optionally with the substrate in an elongated state during metallization and with a cooling of the substrate.

U.S. Pat. No. 5,656,355 also to Cohen issued Aug. 12, 1997. U.S. Pat. No. '355 similarly describes a process for metalizing an elastomeric film.

U.S. Pat. No. 6,191,056 to Vogt issued Feb. 20, 2001. Vogt U.S. Pat. No. '056 describes the addition of a complex primer coating on a previously aluminized or metalized fabric and cross-linking between that primer and both of the metalized particles and the coating layer. Disclosed is a multi-layer bonding wherein each layer is thin and subject to mechanical failures by reason of stresses in either the substrate fabric or the coating layers, or both. Vogt U.S. Pat. No. '056 discloses an improved washfastfulness to about 20 cycles in ordinary household processes.

U.S. Pat. No. 6,824,819 to Vogt issued Nov. 30, 2004. U.S. Pat. No. '819 discloses a cross-linked and thin polyurethane latex coating over both sides of a metalized fabric which is asserted to encapsulate metal particles within the latex coating for improved washfastness. The metallic side comprises a metal coating containing discrete metal particles asserted as encapsulated within the thin cross-linked polymer. It is described that the encapsulation coating serves to resist corrosion of the metal particles adhered to the fabric surface to substantially eliminate failure of the particle substrate bond or destruction of the particles themselves due to abrasion during use, from atmosphere and/or laundering. Any fabric may be used according to this disclosure, including natural fabrics, provided that the thin polyurethane latex thoroughly coats the metal particulate coating so as to substantially prevent contact between the metal and environmental chemicals. Breathability and flexibility are maintained.

U.S. Pat. No. 6,242,369 also to Vogt issued Jun. 5, 2001. U.S. Pat. No. '369 also describes a metalized fabric coated with specific thin polyurethane finishes which themselves must be cross-linked and present in latex form. The particular polyurethanes disclosed are described as ensuring the retention of metal coating within the fabric while protecting the metal from corrosive chemicals. These are noted as applicable to a broad range of fabrics, woven or non-woven, including natural fibres, and describe a coating which is extensible, notably 150%, and are not limited 70 to non-extensible materials. Improved washfastness is claimed for a variety of fabric types including scarves, jackets, blankets, awnings, tents etc.

The Vogt prior art disclosures are directed to the maintenance of the hand of thin metalized fabrics in certain limited uses where the resultant fabric must be washable, particularly in a rotating tub wash basin in the presence of corrosive chemical cleaners. An example of such cleaning would be the use of an ordinary household washer. The test results provided demonstrate that the cross-linked coating of particulate layer is thin and fragile to the extent that it remains exposed to abrasion-type wear and permits a high degree of exposure of the metal particles to chemical destruction from environmental factors such as chemical washing cleaners. These Vogt coated fabrics demonstrate a failure of the isolation provided to the particulate metal and the coating/substrate surface even under ordinary use and cleaning. These failures will result in early degradation of the utility of and the separation of the metalized particulate layer and/or such of the coating layer which remains. As such the fabric is not suitable for long term wear requirements or situations where the metalizing effect must remain intact across edges of the fabric or other situations where the fabric is attached to other fabrics or materials, whether the same or different. This is particularly demonstrated by the description of the process and result equally in respect of natural fibres and man-made fibres. The disclosure provides the degradation process is ‘impeded’ by the barrier while the hand remains soft.

The prior art efforts to date have sought to produce a fully exposed and substantially continuous metal layer over the actual outer surface of a membrane, whether porous or not, or over the nominal outer surface of a fibrous substrate. Stretch resistance was important so as not to cause the metal layer to flake off. Stretchy materials are described as a special case requiring microscopic description. On somewhat more stable fabric substrates the aforementioned US patents to Vogt provide for a specific thin coating process and material over particulate metal deposits so as to thinly encapsulate the metal particles, hold them in place during use and prevent exposure to environmental conditions while maintaining the essential characteristics of the original fabric, particularly hand and breathability. On elastic surfaces a special process was required to maintain integrity and adhesion of the metal layer.

Further, the prior art efforts have sought to maintain hand and flexibility in metalized fabrics while maintaining a substantially continuous metal layer. Use of a particulate metal layer has increased susceptibility to durability issues requiring highly specialized thin coatings providing for encapsulation of metal particles.

The prior art uses emphasize the additional utility of metallization and the many ways in which metallization may be provided while maintaining a portion of the main characteristics of the underlying fabric, including hand, drape and breathability. The addition of the metalized layer has added a whole new set of criteria relating to the maintenance of that metalized layer while the fabric is in use. Of particular importance is the inherent weakness in the fabric itself when it is sought to join the metalized fabric along its edge, as by sewing, to another piece of metalized or other fabric.

In order to maximize the benefits of the metalizing layer it must extend into, and preferably through, the joint area. This is particularly the case where the metalizing fabric is used in thermal camouflage situations. Any break in its thermal characteristics would render the joined fabric useless or require an additional protective layer. Additional layers increase bulk and weight along with increased support structures and likelihood of failure. Stresses in use of such fabric, both during fabrication and beyond, tend to degrade and ultimately destroy the usefulness of the joined fabric and its failure is most likely to occur along the join where the metalizing layer interferes with the structural integrity of the fabric substrate to fabric substrate join.

Addition of a thin sizing layer primarily over a substantially continuous layer of metal or in an attempt to ‘encapsulate’ metal particles merely extends the lifetime of the body of a metalized fabric by a small increment while decreasing the ability of the fabric to be adequately joined to other or similar materials, whether along its edges or otherwise. Maintenance of some of the integrity of the body of the fabric requires that attachment occur primarily by means of sewing where the sewing provides the structural strength across the join. Although sewing is commonly used it is labour intensive and not always suitable to high speed manufacturing situations, particularly with large items such as tents, buildings, camouflage vehicle covers, and awnings or load intensive environments.

The prior art attempts at coated metalized fabrics have sought to provide additional bonding between widely disparate materials, including a broad range of natural fibres, and although some increase in durability has been achieved disclosures such as the various Vogt reference show that substantial gains remain outstanding despite complex and costly chemistry or other methods.

Such weaknesses in the prior art are of particular importance in areas near the edges of such fabrics where the structural integrity of the fabric substrate is at its weakest. An example with respect to a woven fabric would be the outermost strands along an edge which can separate from the body of the fabric by tension in the plane of the fabric such as would occur in a sewn interconnection with an adjacent material. In such circumstances, the principle benefits of the metalizing would be destroyed in a relatively short period of time.

### OBJECTS OF THE INVENTION

The present invention is limited to non-extensible fabrics formed of manufactured filaments and strands of filaments, particularly where the strands have little or no elasticity or extensibility along their individual length. These fabrics may have some capacity for deformation in the plane of the substrate by small changes in the relative direction of the warp and weft or their equivalents.

The present invention seeks to maintain substantially all of the benefits of dimensionally stable man-made fabrics with a non-extensible substrate plus the benefits of metallization while providing that the fabric has an increased durability in a variety of assembly situations and end uses where it may be subject to significant manipulation, stress and degradation.

It is an object of the invention to provide for direct transfer of stresses which may be applied to the fabric, such as by inter-attachment with other such fabrics or other materials, from the coating directly to the substrate without exposing the particulate metal layer to any of abrasive wear, exposure to corrosive chemicals, or substantial separation along either the particle/substrate boundary or the particle/coating boundary. The present invention provides a process of chemically bonding and/or radio frequency (RF) welding of a metalized fabric to adjoining materials, such as an adjacent piece of the same fabric, without significant reduction in strength of the joined materials across the join, which is particularly maintained in the plane of the fabric material.

It is also an object of the present invention to maintain the heat retention and reflection characteristics of a metalized fabric across joins between that fabric and adjacent materials and provide a process by which metalized fabrics may be edge bonded by chemical, mechanical or electrical bonding means.

In accordance with these objects, the invention provides an edge-bonded metalized fabric and process for making same where structural and bending loads across a join in the fabric are taken up by coating layers and substantially reduced across the fragile metal/substrate or metal/coating boundaries.

Further in accordance with these objects, the invention provides a method for edge bonding a metalized dimensionally stable fabric which sufficiently electrically isolates the metal particles from electrical welding equipment in 2 opposed directions (in the plane of the substrate and transverse to that plane) thereby rendering the process more effective, less costly and less prone to failure either in the fabric itself or in arcing between the electrical welding components during fabrication.

The invention provides a mechanical and electrical isolation between the metal particles and there fragile interface with the substrate and the mechanical and electrical strains of assembly and use, particularly in the case of high volume manufacturing situations as is the case of electrical welding by radio frequency where arcing is sufficiently reduced or eliminated, so as to provide for continuous and reliable low cost manufacturing of welded joins.

### DESCRIPTION OF THE INVENTION

The present invention provides a coated fabric with a dimensionally stable non-extensible substrate, a metalized layer comprised of a multiplicity of substantially independent metal particles adhering to said substrate, and a coating layer extending over a substantial portion of said substrate, wherein said coating layer extends through the said layer and penetrates into the substrate, and, wherein said coating layer adheres directly to the substrate, such that substantially all of any stress on the said fabric is transferred directly between the coating layer and the substrate without substantial breakdown of the coating layer.

In a further aspect the invention provides a fabric wherein the substrate is comprised of woven or non-woven made-made fibres and is substantially inelastic and may be substantially non-electrically-conductive.

The metal particles are sufficiently independent of one another so as to prevent any substantial electrical conductivity in the plane of the substrate and the coating sufficiently thick so as to form a substantial electrical barrier in a direction transverse to the plane of the fabric.

In a further aspect the invention provides a pair of such including a bond between respective coating layers formed by chemical or thermal welding between said coating layers. The bond is preferably adjacent an edge of each of said pair of fabrics and is formed by chemical or radio frequency welding.

The present invention also provides a process of bonding coated fabrics including providing a dimensionally stable non-extensible fabric substrate including a metalized layer comprised of a multiplicity of substantially independent metal particles adhering to the substrate on at least one side thereof, providing a coating layer extending over a substantial portion of the substrate, wherein the coating layer extends through the layer and penetrates into the substrate, and, causing the coating layer to adhere directly to the substrate so that substantially all of any stress on the fabric is transferred directly between the coating layer and the substrate without substantial breakdown of the coating layer, and bonding the substrate to an adjacent material.

The process of the invention also provides a process of bonding coated fabrics including bonding both said substrate and said coating layer to said adjacent material by chemical or electrical (RF) welding.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 depicts a plan view of a fabric substrate with a fine weave.

FIG. 2 depicts a cross-section of an individual strand of the substrate of FIG. 1 showing individual filaments.

FIGS. 3a and 3b depict cross-sections of the substrate of FIG. 1 along lines A-A and B-B respectively depicting surface metal particles adhered to the surface of individual strands.

FIGS. 4A and 4B depict a cross-section of the fabric of FIG. 1 along the line A-A, as also depicted in FIG. 3a, depicting the addition of a coating layer to one and both sides of the substrate of FIG. 3a respectively.

FIG. 5 depicts a plan view, as in FIG. 1, of a fabric substrate with an open weave configuration.

FIG. 6 depicts a cross-section of an edge-bonded pair of coated fabrics of the invention as in FIG. 4A.

### DESCRIPTION OF THE PREFERRED EMBODIMENTS

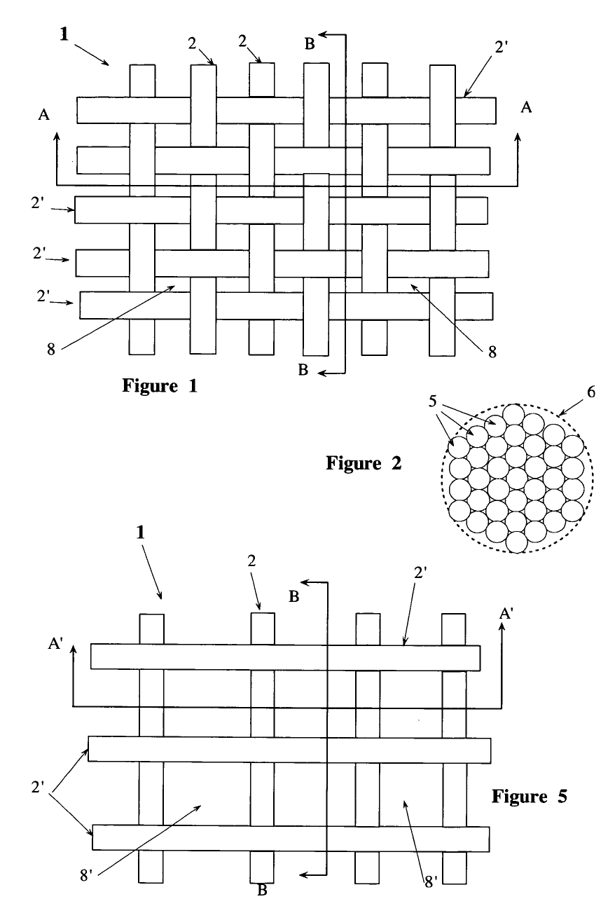

In FIG. 1 is shown an expanded plan view of a typical dimensionally stable fabric substrate I as used with the invention. Warp strands 2 are interwoven with weft strands 2′ in a known fashion. Significant dimensional stability in the fabric substrate 1 is provided along the lines of the warp and weft strands 2 with some off-axis movements as is typical with such woven fabrics. A fine weave is shown wherein interstrands interstices 8 are relatively small and the strands 2 close together in both directions, known as a high thread count.

Preferably each warp and weft strand is formed of a bundle 6 of generally aligned individual filaments 5 as shown in cross-section in FIG. 2. Filaments 5 may be twisted about each other or their length so as to form a self-contained strand with an outer nominal boundary 6.

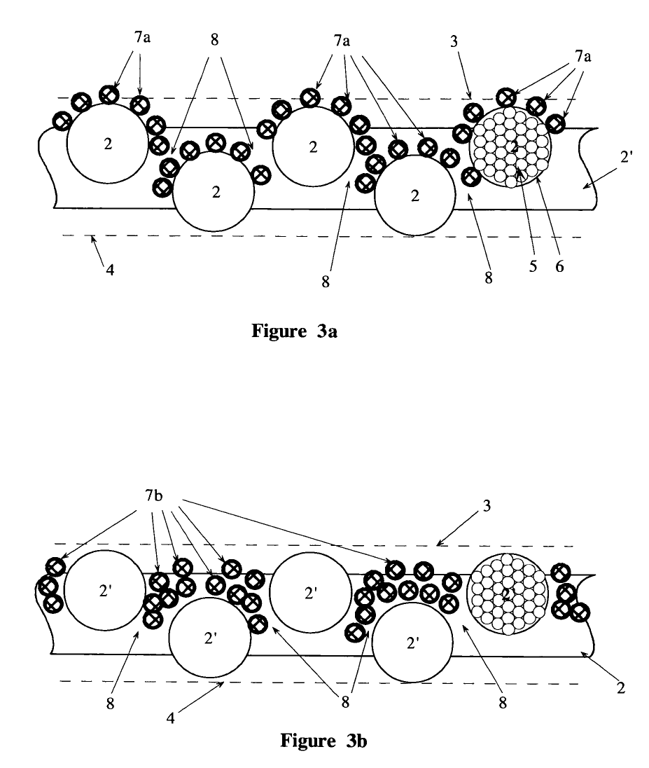

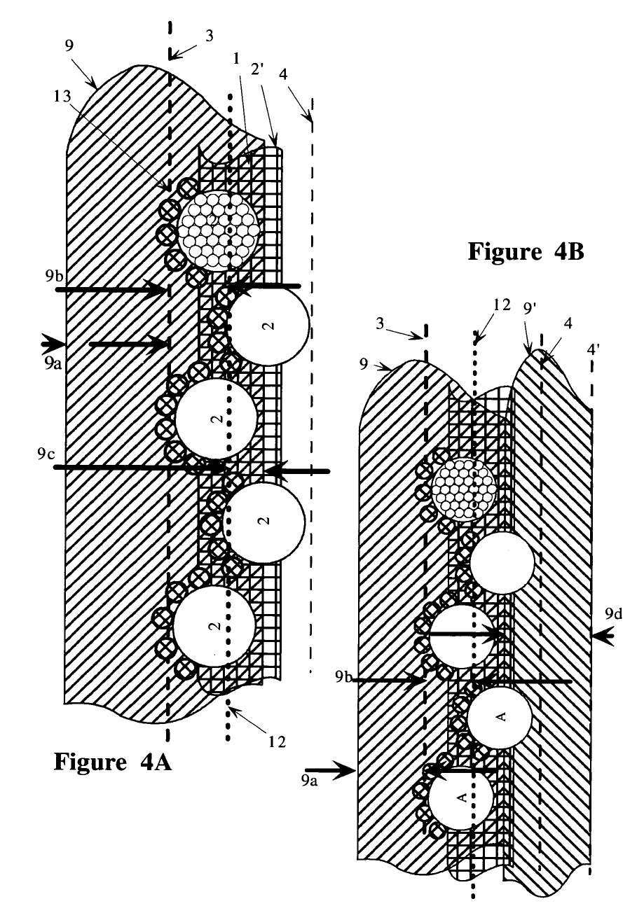

One or both surfaces of the fabric substrate 1 is metalized, preferably with aluminium particles, so as not to form any substantial areas of any continuous layer or areas of continuity, as is depicted in FIG. 3 and following. A variety of processes may be used to provide a chosen degree of metalizing, particularly aluminium particle, density while maintaining a substantially discontinuous metal layering. Of particular utility are fabrics metalized with particulate aluminium as are available commercially from Diversified Fabrics of Kings Mountain, North 280 Carolina, U.S.A. Other metalizing materials are known.

FIGS. 3a and 3b show a cross-section of the substrate fabric 1 taken along the line A-A in FIG. 1 wherein FIG. 3a shows the addition of particulate metal (preferably Aluminium) particles as at 7a adhering to the warp strands 2 and FIG. 3b shows the addition of particulate metal 285 particles as at 7b adhering to the weft strands 2′. The fabric 1 of FIG. 3 is depicted as having been metalized from one side only and depicts a high level of particulate separation, and, thus a low level of particulate density in the plane of the fabric. Relative proximity of the warp and weft, high tread count, provides for small interstices 8 between the strands.

The fabric substrate 1, once metalized, will have a nominal outer metalized surface as at 3 and a nominal non-metalized surface as at 4 in FIGS. 3a and 3b.

Particles 7a and 7b are preferably substantially independent of each other so as not to form any significant continuous metallic layer and so that, during processing, they may adhere in a variety of degrees to the surfaces 6 of the strands 2 and 2′, as in FIGS. 3a and 3b, preferably substantially independently of adjacent particles. Further preferably a substantial degree of adhesion between individual particles 7a and 7b and strands 2 and 2′ is provided by the process of metallization or by subsequent treatments, including thin finishing layers prior to coatings.

FIG. 5 shows a plan view of a fabric similar to that of FIG. 1 but with a loose, known as low thread count, weave and larger interstices 8′ between warp strands 2 and weft strands 2′.

In the preferred embodiment of the invention shown in FIG. 4A the additional coating layer 9 of the invention is shown applied to the fabric of FIG. 3, shown in the view corresponding to FIG. 3a. Coating layer may be continuous or may be provided with a small degree of passages for the transmission of air and moisture. A substantial thickness 9a of layer 9 is shown extending well beyond the nominal outer surface 3 of the fabric substrate 1. The thickness 9a may vary considerably depending upon the manner of manufacture and the intended use for the fabric but preferably is of sufficient thickness to provide for substantial internal integrity, substantial strength in at least the plane of the substrate and substantial electrical resistivity so as to substantially electrically isolate the aluminized substrate 1 from the exterior of the fabric.

Layer 9 extends continuously from nominal outer surface 3 into the fabric substrate 1 a distance 9b towards the substrate nominal centerline 12 and, further preferably, beyond the centerline 12 a further distance 9c. As can be seen coating layer 9 may be applied either completely or substantially from one side of the fabric 1 and may penetrate the substrate 1 to a varying degree.

The material used for layer 9 is preferably thermoplastic and substantially non-conductive and sufficiently free-flowing at the time of application to flow into a substantial portion of not only interstices 8 but also any gaps between and among individual metal particles 7 as at 13.

Further preferably the material of layer 9 has a substantial affinity for a strong chemical and/or mechanical bond with at least the fabric substrate 1 but also the metal particles 7.

A varying degree of mechanical hold and/or adhesion may be obtained by providing for a larger penetration 9b plus 9c into and through the body of substrate 1.

In FIG. 4B the layer 9 of the invention is shown with a portion extending through the substrate 9 a further distance as at 9d and may extend beyond nominal outer surface 4 so as to form a substantially continuous sealed surface as at 4′. Thickness 9d may alternatively be formed through the fabric or by means of a second coating layer 9′ applied to the reverse, non-metalized, side of the substrate 1.

Layer 9 may extend completely across one or both of the faces of the fabric substrate 1 so as to form a continuous and sealed planar material.

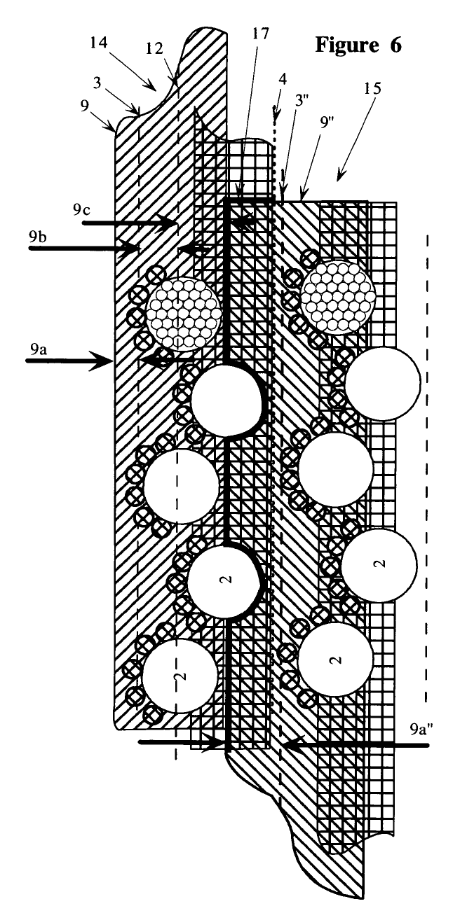

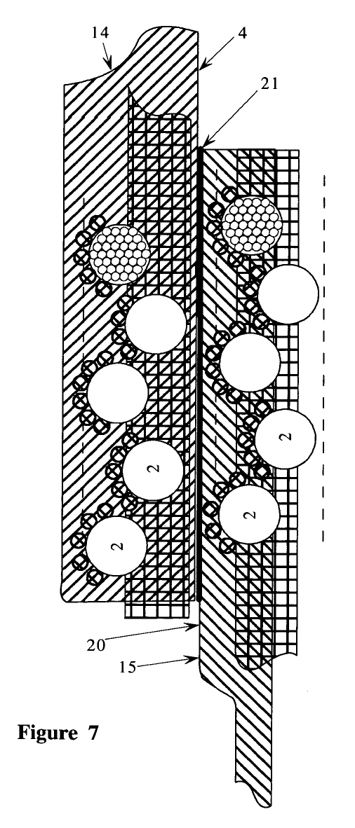

In accordance with the process of the invention two adjacent layers 14 and 15 of fabric substrate 1, coated as is shown in FIG. 4A or 4B, are juxtaposed along their respective edges as shown in FIG. 6. Preferably the metalized side of each of the layers 14 and 15 is towards the same side so as to the available reflectivity of the aluminium particles in both layers.

Joinder of a pair of fabric substrate layers 14 and 15 is accomplished by the chemical bonding of the material of layer 9 on substrate 14 with that of a corresponding layer 9″ in substrate 15 thereby forming a unitary structure. Thickness 9a″ on layer 15 is brought into juxtaposition with nominal outer surface 4. Preferably or alternatively, in accordance with the preferred embodiment of the invention, chemical bonding is achieved by radio frequency welding along edge line 17 of the layers without the need for additional bonding agents.

Layers 9 may be made thicker or applied to both sides of fabric substrate 1 in both or one of the adjoining layers 14 and 15 in order to accommodate a variety of different radio frequency welding circumstances and in order to increase the electrical isolation of the metal particles from the welding equipment in a direction perpendicular to the plane of the layers 14 and 15.

Also preferably the density of metal particles may be adjusted to as to maintain the desired degree of electrical resistance in the plane of the fabric.

Most preferably layer 14 extends on both sides of substrate 1 in accordance with the substrate depicted in FIG. 4B. As depicted in FIG. 7 the joined fabric of FIG. 4B is thereby provided with a relatively planar nominal outer surface 4 which may then be bonded to the outer surface 20 of layer 15 along planar surface 21.

Preferably the coating layer 9 is formed of material which bonds directly to the synthetic substrate 1 and remains substantially intact across a substantial area of said substrate 1 when under stress both in the plane of the substrate 1 and transverse thereto. Stresses are transferred directly to the substrate 1 without any substantial impact on either the bond between the metal particles 7a and 7b and the substrate 1 or upon the exposure of said particles to corrosive external conditions. Loads, whether in the plane of the substrate 1 or transverse thereto, or both, are transferred within the coating layer 9 across the plane of the fabric so as to minimize point to point stress between the coating and any particular element of the metalized substrate 1 in a load-sharing manner.

Also most preferably, the fabric substrate 1 of the invention comprises dimensionally stable synthetic fibres in a raw or printable condition, namely without pre-coatings. Additionally, the coating layer 9 may be formed of a substantially pliable and sufficiently non-extensible nature so that elongation, fracturing or separation under stress is avoided, thus maintaining the integrity of the fabric as a whole and the metalized layer in particular.

As can be seen, the resultant joined fabric provides a continuous favourable metalized effect in a direction perpendicular to the plane of the substrate across a structurally sound join without unduly loading the metal component or its weak bond to the substrate. Stress on the joined fabric is directed along its plane away from the weakest portions of the bonding and away from the direction transverse to the plane for enhanced edge strength.

While the invention has been described in connection with the above described embodiments, it is not intended to limit the scope of the invention to the particular forms set forth, but on the contrary, it is intended to cover such alternatives, modifications, and equivalents as may be included within the scope of the invention.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What we claim is:

1. A coated fabric comprising:
a) a dimensionally stable non-extensible substrate,
b) a metalized layer comprised of a multiplicity of substantially independent metal particles adhering to said substrate,
c) a coating layer extending over a substantial portion of said substrate,
d) wherein said coating layer extends through the said layer and 10 penetrates into the substrate, and,
e) wherein said coating layer adheres directly to the substrate,
f) such that substantially all of any stress on the said fabric is transferred directly between the coating layer and the substrate without substantial breakdown of the coating layer.

2. A coated fabric as claimed in claim 1 wherein said substrate is comprised of woven or non-woven made-made fibres.

3. A coated fabric as claimed in claims 1 or 2 wherein said coating layer is substantially inelastic.

4. A coated fabric as claimed in claim 3 wherein said coating layer is substantially non-electrically conductive.

5. A coated fabric as claimed in claim 4 wherein said metal particles are sufficiently independent of one another so as to prevent any substantial electrical conductivity in the plane of the substrate.

6. A coated fabric as claimed in claim 4 wherein said coating layer is sufficiently thick so as to form a substantial electrical barrier in a direction transverse to the plane of the fabric.

7. A coated fabric as claimed in claim 6 where said metal particles are sufficiently independent of one another so as to prevent any substantial electrical conductivity in the plane of the substrate.

8. A pair of coated fabrics as claimed in claims 1 or 2 further comprising a bond between said respective coating layers.

9. A pair of coated fabrics as claimed in claim 8 wherein said bond is formed by chemical or thermal welding between said coating layers.

10. A pair of coated fabrics as claimed in claim 9 wherein said coating layers are substantially inelastic.

11. A pair of coated fabrics as claimed in claim 10 wherein said metal particles are sufficiently independent of one another so as to prevent any substantial transfer of mechanical stress directly between said particles.

12. A pair of coated fabrics as claimed in claim 10 wherein said coating layer is sufficiently thick so as to form a substantial mechanical barrier in a direction transverse to the plane of the fabric.

13. A pair of coated fabrics as claimed in claim 11 wherein said metal particles are sufficiently independent of one another so as to prevent any substantial transfer of mechanical stress directly between said particles.

14. A pair of coated fabrics as claimed in claim 13 wherein said bond is adjacent an edge of each of said pair of fabrics.

15. A pair of coated fabrics as claimed in claim 14 wherein said bonding is formed by radio frequency welding.

16. A pair of coated fabrics as claimed in claim 15 wherein said coating layer is substantially non-electrically conductive.

17. A pair of coated fabrics as claimed in claim 16 wherein said coating layer is substantially inelastic.

18. A pair of coated fabrics as claimed in claim 17 wherein said metal particles are sufficiently independent of one another so as to prevent any substantial electrical conductivity in the plane of the substrate.

19. A pair of coated fabrics as claimed in claim 17 wherein said coating layer is sufficiently thick so as to form a substantial electrical barrier in a direction transverse to the plane of the fabric.

20. A pair of coated fabrics as claimed in claim 19 wherein said metal particles are sufficiently independent of one another so as to prevent any substantial electrical conductivity in the plane of the substrate.

21. A process of bonding coated fabrics comprising:
a) providing a dimensionally stable non-extensible fabric substrate including a metalized layer comprised of a multiplicity of substantially independent metal particles adhering to said substrate on at least one side thereof,
b) providing a coating layer extending over a substantial portion of said substrate, wherein said coating layer extends through a said layer and penetrates into the substrate, and,
c) causing said coating layer to adhere directly to the said substrate so that substantially all of any stress on the said fabric is transferred directly between the coating layer and the substrate without substantial breakdown of the coating layer, and
d) bonding said substrate to an adjacent material.

22. A process of bonding coated fabrics as claimed in claim 21 further comprising bonding both said substrate and said coating layer to said adjacent material.

23. A process of bonding coated fabrics as claimed in claim 22 wherein said adjacent material is a coated fabric with a metalized layer on a metalized side thereof.

24. A process of bonding coated fabrics as claimed in claim 22 or 23 wherein said adjacent coated fabric is bonded to said substrate on a side opposite from said first metalized layer.

25. A process of bonding coated fabrics as claimed in claim 24 wherein said adjacent coated fabric is bonded to both said substrate and said coating layer.

26. A process of bonding coated fabrics as claimed in claim 25 wherein said bonding is provided by electrical welding.

27. A process of bonding coated fabrics as claimed in claim 26 wherein said electrical welding is provided by radio frequency welding.
